(19) United States
(12) Patent Application Publication
(10) Pub. No.: US 2011/0225948 A1
(43) Pub. Date: Sep. 22, 2011

(54) APPARATUS FOR HIGH-FREQUENCY ELECTROMAGNETIC INITIATION OF A COMBUSTION PROCESS

(76) Inventors: Almaz Kamilevich Valeev, Moscow (RU); Sergey Adolfovich Oskin, Moscow (RU); Sergey Anatolievich Meshkov, Moscow (RU); Valery Alexandrovich Mitrofanov, Moscow (RU); Dmitry Vladlenovich Tretvakov, Moscow (RU)

(21) Appl. No.: 13/036,040

(22) Filed: Feb. 28, 2011

(30) Foreign Application Priority Data
Mar. 18, 2010 (RU) 2010110031

(51) Int. Cl. F02C 7/264

(52) U.S. Cl. 60/39.821

(57) ABSTRACT

Apparatus for providing electromagnetic radiation to a combustor during a combustion process are disclosed. An electromagnetic radiation source delivers electromagnetic radiation through a first waveguide to a second waveguide that includes an electromagnetic radiation outlet positioned to deliver electromagnetic radiation to the interior of the combustor. Electromagnetic radiation is delivered to low temperature regions of a combustor to reduce carbon monoxide (CO) and unburned hydrocarbon (UHC) emissions. In addition, the electromagnetic radiation stimulates the combustion process so that lean air-fuel mixtures and low BTU gases can be burned at lower combustion temperatures leading to reduced NOx emissions.

### FIELD OF THE INVENTION

The present disclosure relates generally to gas turbine combustors and, more particularly, to the use of high-frequency electromagnetic radiation during a combustion process in a combustor of a gas turbine.

### BACKGROUND OF THE INVENTION

Gas turbines are widely used in commercial operations for power generation. A typical gas turbine includes a compressor at the front, one or more combustors around the middle, and a turbine at the rear. The compressor imparts kinetic energy to the working fluid (air) to bring it to a highly energized state. The compressed working fluid exits the compressor and flows to the combustors. The combustors mix fuel with the compressed working fluid, and the mixture of fuel and working fluid ignites to generate combustion gases having a high temperature, pressure, and velocity. The combustion gases flow to the turbine where they expand to produce work.

Gas turbines are becoming increasingly required to perform at higher efficiencies while producing less emissions. Higher efficiencies can be achieved by increasing the burning temperature of the fuel mixture in the combustors of the gas turbine. Higher burning temperatures, however, can lead to increased emissions, such as increased NOx emissions. Thus, there is often a trade off between higher efficiency combustion and the reduction of NOx emissions. Moreover, low BTU fuels are often relatively inexpensive when compared to other fuels. However, low BTU fuels can be difficult to burn and can also lead to increased NOx emissions.

NOx emissions can be reduced by using lower burning temperatures. Lower burning temperatures can be achieved by supplying a lean air-fuel mixture to the combustor. Lower burning temperatures, however, can result in excessive carbon monoxide (CO) and unburned hydrocarbon (UHC) emissions due to incomplete fuel combustion that can result from lower burning temperatures. Moreover, CO and UHC emissions can also result from operating a gas turbine at low load, such as during turndown conditions.

A lower temperature, higher efficiency combustion process can be achieved through use of high-frequency electromagnetic radiation during the combustion process. For instance, U.S. Pat. No. 5,370,525 discloses that combustion can be enhanced by positioning plural magnetrons around a burner and directing microwaves into a combustion zone. The use of electromagnetic radiation during combustion can lead to the production of free radicals that support the afterburning of CO and other UHC, leading to lower CO and UHC emissions. In addition, the electromagnetic radiation stimulates fuel combustion by exciting carbon atoms in the fuel, increasing the efficiency of the combustion process.

Existing systems for providing high-frequency electromagnetic radiation to the combustion zone of a combustor can require complex modifications to the existing structure of the combustor. In addition, such systems often do not simultaneously provide electromagnetic radiation from a single source to multiple different regions of the gas turbine. Moreover, existing systems may not provide the capability to focus the application of high-frequency electromagnetic radiation to low temperature regions of a combustor, such as proximate to unfired fuel nozzles for the combustor or to non-flame regions of the combustor.

Thus, an apparatus and system for providing high-frequency electromagnetic radiation to a combustion zone of a combustor that overcomes the above disadvantages and allows for a more efficient combustion process at reduced temperatures with less NOx, CO, and UHC emissions would be welcome in the art.

### BRIEF DESCRIPTION OF THE INVENTION

Aspects and advantages of the invention will be set forth in part in the following description, or may be obvious from the description, or may be learned through practice of the invention.

One exemplary embodiment of the present disclosure is directed to an apparatus for providing electromagnetic radiation to a combustor during a combustion process. The combustor includes a fuel nozzle for supplying a fuel mixture to the combustor. The apparatus includes an electromagnetic radiation source, a first waveguide coupled to the electromagnetic radiation source, and a second waveguide coupled to the first waveguide. The second waveguide includes an electromagnetic radiation outlet positioned to deliver electromagnetic radiation to a low temperature region of the combustor. During the combustion process, the low temperature region has an operating temperature that is less than a temperature for sustaining combustion of the fuel mixture without the electromagnetic radiation.

Another exemplary embodiment of the present disclosure is directed to an apparatus for providing electromagnetic radiation to a combustor during a combustion process. The apparatus includes an electromagnetic radiation source and a first waveguide coupled to the electromagnetic radiation source. The apparatus further includes an annular manifold waveguide coupled to the first waveguide and a branch waveguide coupled to and extending from the manifold waveguide. The branch waveguide includes an electromagnetic radiation outlet positioned adjacent an opening in a wall of the combustor.

Another exemplary embodiment of the present disclosure is directed to an apparatus for providing electromagnetic radiation to a combustor during a combustion process. The apparatus includes an electromagnetic radiation source, a first waveguide coupled to the electromagnetic radiation source, and a second waveguide coupled to the first waveguide. The second waveguide includes a first tube structure mounted within a fuel nozzle of the combustor.

Variations and modifications can be made to these exemplary embodiments of the present disclosure.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts a cutaway perspective view of an apparatus for providing electromagnetic radiation to a combustor according to an exemplary embodiment of the present disclosure;

FIG. 2 depicts a sectional view of an apparatus for providing electromagnetic radiation to a combustor according to an exemplary embodiment of the present disclosure;

FIG. 3 depicts a sectional view of an electromagnetic radiation outlet used in an apparatus for providing electromagnetic radiation to a combustor according to an exemplary embodiment of the present disclosure;

FIG. 4 depicts a sectional view of an apparatus for providing electromagnetic radiation to a combustor according to an exemplary embodiment of the present disclosure;

FIG. 5 depicts a sectional view of an apparatus for providing electromagnetic radiation to a combustor according to an exemplary embodiment of the present disclosure; and

FIG. 6 depicts a sectional view of an apparatus for providing electromagnetic radiation to a combustor according to an exemplary embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present disclosure is directed to an apparatus and system for providing electromagnetic radiation to a combustor during a combustion process. While the present disclosure will be discussed with reference to a combustor used to generate combustion gases for use in a gas turbine, those of ordinary skill in the art, using the disclosures provided herein, should readily understand that the present invention is equally applicable to any combustion process.

Embodiments of the present disclosure are used to provide high-frequency electromagnetic radiation, such as microwave radiation or other suitable high-frequency electromagnetic radiation, to the interior of a combustor to enhance the combustion process and to reduce emissions produced during the combustion process. The high-frequency electromagnetic radiation has a frequency and power sufficient to generate a tangle of plasma streamers in an oscillating field created by the electromagnetic radiation. The plasma streamers can be concentrated in low temperature regions of the combustor such as in an non-flame zone near an unfired fuel nozzle. The plasma streamers produce electrons and ultraviolet radiation that support the afterburning of any unburned CO or UHC in the combustor. In addition, the plasma streamers can stimulate the combustion process by exciting carbon atoms in the fuel ignited in the combustor.

The enhanced combustion provided by the application of high-frequency electromagnetic radiation allows for the use of a lean air-fuel mixture or a low BTU fuel mixture in the base load regime that normally would not burn without the application of electromagnetic radiation. Use of such lean air-fuel mixture or low BTU fuel can result in reduced burning temperatures for the combustion process, leading to reduced NOx emissions. Moreover, the radicals generated by the plasma streamers in low temperature regions of the combustor during the combustion process support the afterburning of CO and UHC, leading to reduced CO and UHC emissions.

Additionally, embodiments of the present disclosure can be used to support the efficient combustion of fuel during operation of a gas turbine in a low load regime. For example, during turn down conditions of a gas turbine, electromagnetic radiation can be provided to the combustors of the gas turbine to support efficient combustion and reduced CO and UHC emissions despite low temperature regions in the combustors.

The electromagnetic radiation can be applied to the interior of the combustor by an annular manifold waveguide that surrounds the combustor or through a fuel nozzle equipped with a waveguide. The annular manifold waveguide and fuel nozzle waveguide embodiments can be particularly configured for emitting electromagnetic radiation to low temperature regions of the combustor interior. As used herein, a “low temperature region” of a combustor is intended to refer to a region in the combustor that has an operating temperature during the combustion process that is less than a temperature for sustaining combustion of a fuel mixture in the interior of the combustor without application of electromagnetic radiation.

The annular manifold waveguide and fuel nozzle waveguide can be implemented without major structural modifications to the combustor. The annular manifold waveguide and fuel nozzle waveguide can also provide electromagnetic radiation to multiple regions of the combustor at the same time from a single electromagnetic radiation source. Indeed, the annular manifold waveguide and fuel nozzle waveguides can be configured to deliver simultaneously electromagnetic radiation to multiple low temperature regions of the combustor interior, such as adjacent to multiple unfired fuel nozzles. In this manner, embodiments of the present disclosure can provide for the efficient reduction of CO and UHC emissions, expansion of stabilized combustor operation range, and fuel savings by allowing gas turbine operation outside a base load regime.

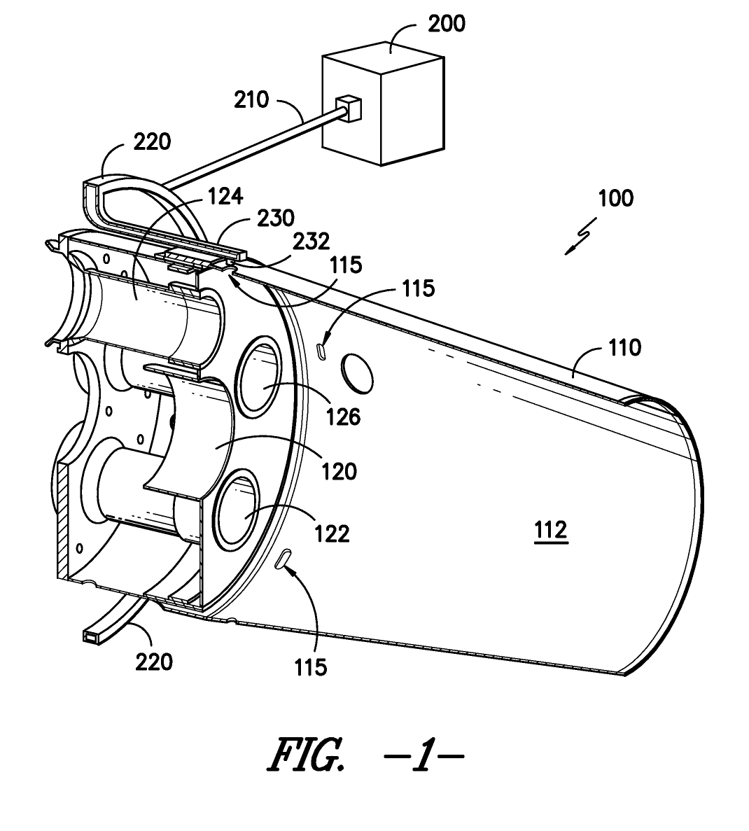

With reference now to FIG. 1, a first exemplary embodiment of the present disclosure will now be discussed in detail. FIG. 1 provides a cutaway perspective view of a cylindrical combustor 100 that includes an apparatus for providing electromagnetic radiation to combustor 100. The combustor 100 is illustrated in cutaway perspective view to illustrate the interior 112 of combustor 100.

As illustrated, combustor 100 includes a combustor wall 110 and a combustor interior 112. Combustion processes take place inside combustor interior 112. Combustor 100 includes a plurality of fuel nozzles, including central fuel nozzle 120 and peripheral fuel nozzles 122, 124, and 126. Peripheral fuel nozzles 122, 124, and 126 are disposed in a radially spaced apart relationship with respect to central fuel nozzle 120. Combustor 100 can include any number of peripheral fuel nozzles without deviating from the scope of the present disclosure.

Central fuel nozzle 120 and peripheral fuel nozzles 122, 124, and 126 are used to deliver an air-fuel mixture to combustor interior 112. The air-fuel mixture is ignited in combustor interior 112 to generate combustion gases having a high temperature, pressure, and velocity that are used to produce work in a gas turbine. As will be discussed in more detail below, electromagnetic radiation is provided to combustor interior 112 to increase the efficiency of the combustion processes in combustor interior 112.

An electromagnetic radiation source 200 is used to generate the high-frequency electromagnetic radiation for combustor 100. Electromagnetic radiation source 200 is preferably located apart from combustor 100 to avoid detrimental heating effects that can be caused from combustor 100. In a particular embodiment, electromagnetic radiation source 200 comprises a magnetron configured to generate microwave energy. However, other suitable high-frequency electromagnetic radiation sources can be used without deviating from the scope of the present disclosure. The particular type of electromagnetic radiation source will be determined based on the particular application and the type of high-frequency energy signal provided to combustor 100. For instance, the electromagnetic radiation source 200 can be configured to provide a pulsed electromagnetic radiation signal to combustor 100.

Electromagnetic radiation source 200 is coupled to a first waveguide 210 for delivering electromagnetic radiation to a second waveguide, such as an annular manifold waveguide 220. First waveguide 210 can be any type of structure for guiding the electromagnetic radiation generated by electromagnetic generator 200. For instance, first waveguide 210 can include a hollow structure dimensioned to deliver electromagnetic waves that propagate the length of the waveguide in transverse electric (TE) mode or transverse magnetic (TM) mode by bouncing off the internal walls of the hollow structure. In another embodiment, first waveguide 210 can have a coaxial configuration to provide for transverse electric and magnetic (TEM) mode propagation. The size and configuration of waveguide 210 can vary as a matter of design choice. For instance, first waveguide 210 can actually include a plurality of coupled waveguides.

First waveguide 210 is coupled to annular manifold waveguide 220. Annular manifold waveguide 220 can be any suitable waveguide configured to deliver high-frequency electromagnetic radiation in TE mode, TM mode or other suitable propagation mode. For example, annular manifold waveguide 220 can be a hollow structure dimensioned to allow for TE mode or TM mode propagation of electromagnetic radiation. Annular manifold waveguide 220 is illustrated in FIG. 1 as generally having a ring shape that surrounds a portion of combustor 100. However, annular manifold waveguide 220 is not limited to such ring shape and can include other shapes, such as a rectangular shape, polygonal shape or other suitable shape that is capable of generally encircling combustor 100.

Annular manifold waveguide 220 does not have to form a complete ring or completely encircle combustor 100. Indeed, annular manifold waveguide 220 can include a partial annular section or multiple partial annular sections as desired. For instance, annular manifold waveguide 220 can include a semicircular shaped waveguide that encircles about 10%, about 20%, about 30%, about 40%, about 50%, about 60%, about 70%, about 80%, about 90%, about 100% or any other percentage of the circumference of combustor 100 without deviating from the scope of the present disclosure.

Annular manifold waveguide 220 generally encircles combustor 100 to provide multiple locations for transmission of electromagnetic radiation into combustor interior 112. In particular, at least one branch waveguide 230 is coupled to and extends from annular manifold waveguide 220. Similar to annular manifold waveguide 220, branch waveguide 230 can be a hollow structure configured to deliver high-frequency electromagnetic radiation in TE mode, TM mode, or any other suitable propagation mode. The branch waveguide 230 depicted in FIG. 1 is a hollow structure in which electromagnetic waves propagate the length of the branch waveguide 230 in TE mode or TM mode by bouncing off the internal walls of the hollow structure.

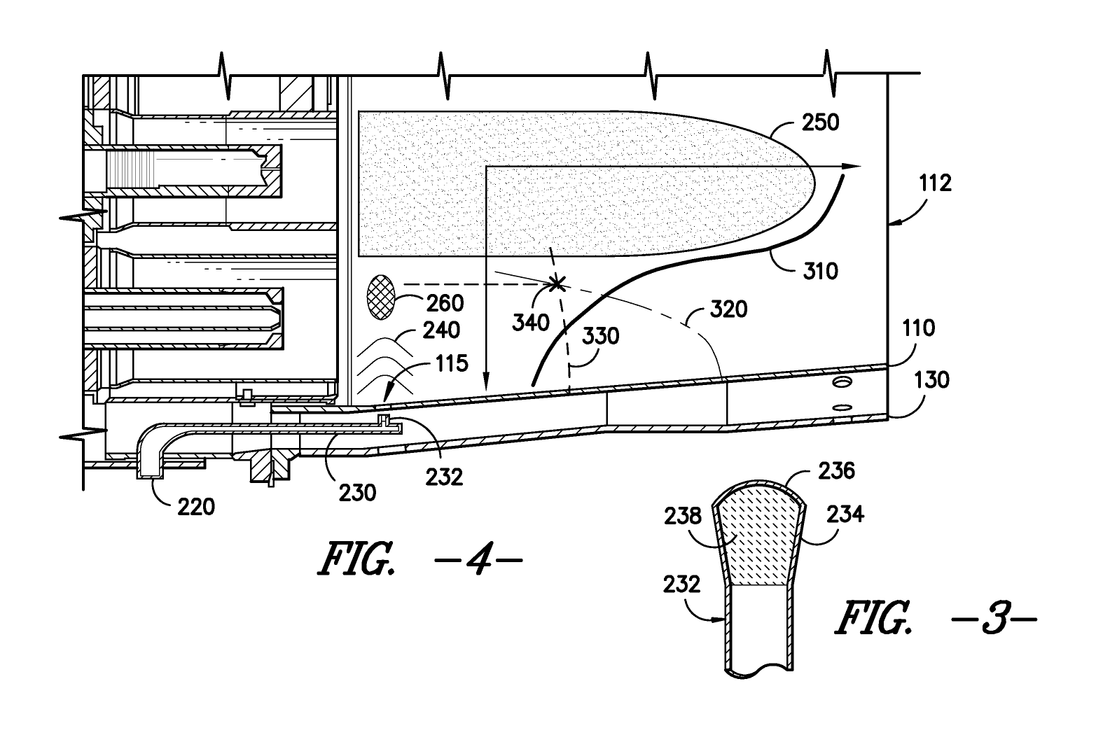

Branch waveguide 230 delivers electromagnetic radiation to electromagnetic radiation outlet 232. Electromagnetic radiation outlet 232 can be a slot antenna or other suitable outlet for directing electromagnetic radiation into combustor interior 112. FIG. 3 illustrates one exemplary embodiment of electromagnetic radiation outlet 232. As illustrated in FIG. 3, electromagnetic radiation outlet 232 can generally include a bell mouth 234 for improving inductive coupling of the electromagnetic radiation to the combustor interior 112. In addition, electromagnetic radiation outlet 232 can include a plug 236 of dielectric material 238 inserted into bell mouth 234. Dielectric material 238 can provide for the sealing of the interior structure of the electromagnetic radiation outlet 232, branch waveguide 230, and annular manifold waveguide 220 assembly to prevent contamination or other harmful effects.

Referring back to FIG. 1, electromagnetic radiation outlet 232 is positioned adjacent to opening 115 provided in combustor wall 110. Opening 115 in combustor wall 110 is positioned adjacent peripheral fuel nozzle 124 to focus the application of electromagnetic radiation to a region in combustor interior 112 adjacent peripheral fuel nozzle 124. Similar to electromagnetic radiation outlet 232, opening 115 can similarly include a plug or cap of dielectric material to keep combustor interior 112 sealed from the external environment.

Combustor wall 110 can include a plurality of openings 115. Each opening 115 can be positioned proximate to a peripheral fuel nozzle, such as proximate to one of peripheral fuel nozzles 122, 124, and 126. In accordance with a particular embodiment of the present disclosure, a plurality of branch waveguides 230 can extend from annular manifold waveguide 220 such that an electromagnetic radiation outlet 232 located at the end of each branch waveguide 230 is positioned adjacent to each of the plurality of openings 115. In this manner, the annular manifold waveguide 220 can simultaneously deliver electromagnetic radiation to multiple regions of the combustor interior 112 with minimal modification to the structure of combustor 100.

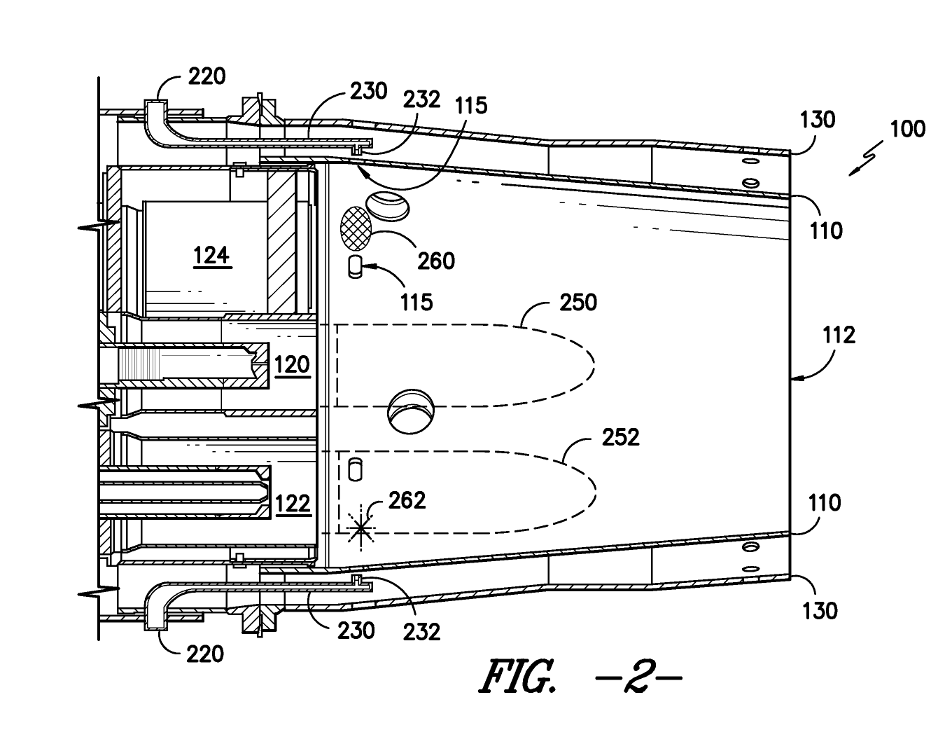

With reference to FIG. 2, the operation of the exemplary embodiment depicted in FIG. 1 will now be discussed in detail. As illustrated, annular manifold waveguide 220 surrounds a portion of combustor 100 and includes a plurality of branch waveguides 230 coupled to and extending from annular manifold waveguide 220. Branch waveguides 230 are disposed in a clearance defined between combustor wall 110 and outer shell 130 of combustor 100. In this manner, branch waveguides 230 can be shielded from view and protected from damage. Each branch waveguide 230 includes an electromagnetic radiation outlet 232 positioned to deliver electromagnetic radiation to the combustor interior 112 adjacent one of the peripheral fuel nozzles, such as peripheral fuel nozzles 122 and 124. In particular, each electromagnetic radiation outlet 232 is positioned adjacent an opening 115 defined in combustor wall 110 and each opening 115 is positioned proximate to one of the peripheral fuel nozzles.

In accordance with embodiments of the present disclosure, high-frequency electromagnetic radiation is delivered to annular manifold waveguide 220 from an electromagnetic radiation source. Electromagnetic radiation travels around annular manifold waveguide 220 and splits off into branch waveguides 230. The electromagnetic radiation is then delivered from electromagnetic radiation outlets 232 through openings 115 in combustor wall 110 into the combustor interior 112.

The annular manifold waveguide 220 allows for the focus of electromagnetic radiation in low temperature regions of the combustor interior, such as adjacent unfired fuel nozzles or non-flame zones of combustor 100. For example, in FIG. 2, fuel nozzles 120 and 122 have been fired to create flame zones 250 and 252 respectively. Fuel nozzle 124 remains unfired, which can lead to a low temperature region of combustor interior 112 and can lead to unburned CO and UHC.

To address the unburned CO and UHC, high-frequency electromagnetic radiation is delivered to combustor interior 112 from annular manifold waveguide 220. The flame zone 252 blocks the electromagnetic radiation being delivered from the electromagnetic radiation outlet 232 adjacent to peripheral fuel nozzle 122 as indicated at 262. However, there is no flame zone to block the electromagnetic radiation being delivered adjacent to unfired fuel nozzle 124. The electromagnetic radiation is then redistributed through annular manifold waveguide 220 and delivered to the region proximate unfired fuel nozzle 124. As will be discussed in more detail below, the electromagnetic radiation will create a tangle of plasma streamers 260 in the region adjacent to unfired fuel nozzle 124. The tangle of plasma streamers 260 produces radicals to support the afterburning of the unburned CO and UHC in a low temperature region of the combustor interior 112.

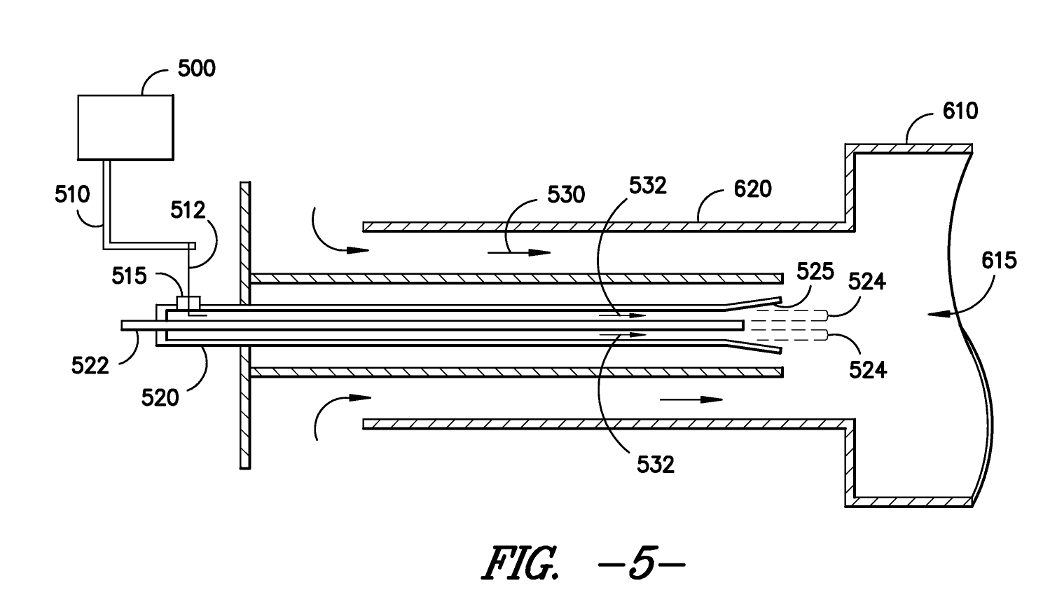

Referring to FIG. 4, the generation of the tangle of plasma streamers 260 in a low temperature region of the combustor interior 112 will now be discussed in detail. FIG. 4 provides a sectional view of a portion of combustor 100. High-frequency electromagnetic radiation 240 is delivered to combustor interior 112 from annular manifold waveguide 220, branch waveguide 230, and electromagnetic radiation outlet 232. The electromagnetic radiation 240 is delivered through opening 115 positioned proximate an unfired peripheral fuel nozzle.

A chart is superimposed on the combustor interior 112 to illustrate temperature curve 310, gas breakdown strength curve 320, and inducted electromagnetic radiation strength curve 330 as a function of position in the gas turbine. Temperature curve 310 illustrates that gas turbine interior temperature can vary from about 550 K at its lowest to about 1800 K at its peak. The region adjacent the unburned fuel nozzle has a temperature closer to about 550 K and can be considered a low temperature region of combustor interior 112.

As illustrated by curve 320, gas breakdown strength decreases as one moves from a low temperature region to a higher temperature region of combustor interior 112. To support the breakdown of gas and burning of gas in the low temperature region, additional energy must be provided to gas turbine interior 112 at the low temperature region. Electromagnetic radiation strength curve 330 depicts inducted strength of electric fields in combustor interior. At a point 340 where the electromagnetic radiation strength exceeds the gas breakdown strength of the gas, an electric breakdown will take place and plasma streamers will be formed. Plasma streamers moving in the oscillating electromagnetic field created by the electromagnetic radiation will form a tangle of plasma streamers. The tangle of plasma streamers will lead to the production of electron and ultraviolet emissions and the production of radicals to support the afterburning of CO and UHC in the low temperature region of the combustor interior 112.

Because the gas dynamic and combustion processes can be very slow, the electromagnetic radiation source 200 of FIG. 1 can be operated in a pulse regime to provide to reduce power requirements for electromagnetic radiation source 200 operation. For example, in a particular embodiment, the electromagnetic signal delivered from electromagnetic radiation source can have a carrier frequency of about 1 GHz to about 30 GHz, such as about 8 GHz to about 12 GHz, a pulse frequency of about 5 KHz to about 50 KHz, such as about 10 KHz to about 30 KHz, and a power of about 60 kW to about 100 kW.

In this particular embodiment, the first waveguide 210, annular manifold waveguide 220, and branch waveguide 230 can include a rectangular tube of about 10 mm by about 24 mm to deliver electromagnetic radiation to combustor interior 112. The electromagnetic radiation can propagate in TE mode or TM mode through first waveguide 210, annular manifold waveguide 220, and branch waveguide 230 and provide an electric field strength of about 800 kV/m to about 900 kV/m.

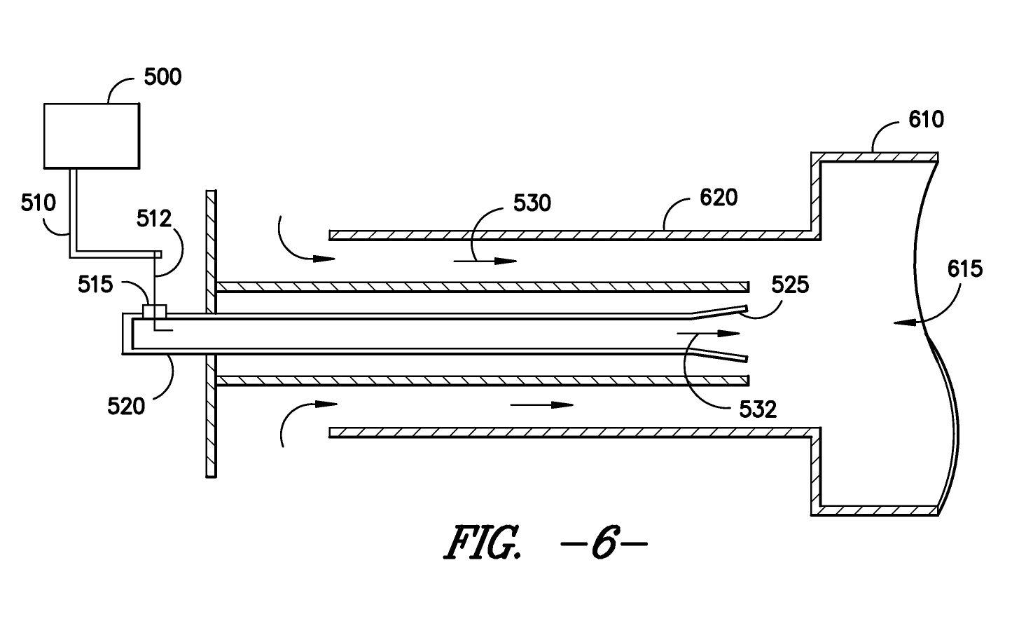

FIG. 5 and FIG. 6 depict sectional views of variations of an apparatus for delivering electromagnetic radiation to a combustor according to an exemplary embodiment of the present disclosure. In this exemplary embodiment, the fuel nozzle itself includes a waveguide for delivery of electromagnetic radiation into a combustor interior. If the fuel nozzle is fired, the fire zone will block delivery of electromagnetic radiation into the combustor interior. If the fuel zone is unfired, the electromagnetic radiation will be provided to a region in the combustor interior adjacent to the unfired fuel nozzle. As discussed above, this will support afterburning of unburned CO and UHC in the region adjacent the unfired fuel nozzle. While this exemplary embodiment is discussed below with reference to one exemplary fuel nozzle, those of ordinary skill in the art should understand that the apparatus can be implemented in one or more fuel nozzles for a combustor as desired.

FIG. 5 depicts an exemplary fuel nozzle 620 for providing fuel to combustor interior 615 of combustor 610. An air-fuel mixture is provided to combustor interior 615 from fuel nozzle 620 as indicated by flow arrow 530. The air-fuel mixture is ignited in combustor interior 615 to generate combustion gases having a high temperature, pressure, and velocity.

An electromagnetic radiation source 500 is used to generate high-frequency electromagnetic energy for combustor 610. Electromagnetic radiation source 500 is preferably located apart from combustor 610 to avoid detrimental heating effects. In a particular embodiment, electromagnetic radiation source 500 comprises a magnetron configured to generate microwave energy. However, other suitable high-frequency electromagnetic radiation sources can be used without deviating from the scope of the present disclosure. The particular type of electromagnetic radiation source 500 can be determined based on the particular application and the type of electromagnetic radiation signal provided to combustor 610. For instance, electromagnetic radiation source 500 can be configured to provide a pulsed electromagnetic radiation signal to combustor 610

First waveguide 510 is used to provide electromagnetic radiation from an electromagnetic radiation source 500. First waveguide 510 can be any structure for guiding electromagnetic radiation provided from electromagnetic radiation source. For instance, first waveguide 510 can be a rectangular hollow structure dimensioned to deliver electromagnetic waves that propagate the length of first waveguide 510 in TE mode or TEM mode by bouncing of the walls of the hollow structure. In another embodiment, first waveguide 510 can have a coaxial configuration to allow for TEM propagation. The size and configuration of waveguide 510 can vary as a matter of design choice. For instance, first waveguide 510 can actually include a plurality of coupled waveguides.

First waveguide 510 is coupled to a second waveguide mounted inside fuel nozzle 620 through conductor 512. Second waveguide can include a first tube structure 520 mounted within fuel nozzle 620. Conductor 512 is used to provide electromagnetic radiation from first waveguide 510 to the second waveguide. For instance, in a particular embodiment, conductor 512 can be coupled to a first wave antinode provided in first waveguide 510 and a second wave antinode provided in first tube structure 520 of the second waveguide. The conductor 512 can be provided to first tube structure 520 through a hole provided in the wall of the first tube structure 520. A dielectric cap 515 can be provided at the hole provided in the wall of first tube structure 520 to seal the first tube structure from the external environment.

The second waveguide includes first tube structure 520 mounted within fuel nozzle 620. First tube structure 520 can include a bell mouth 525 for improving indicative coupling between first tube structure 520 and combustor interior 615. A second tube structure 522 is located within first tube structure 520. Second tube structure 522 can be constructed to be hollow or can be solid piece. A clearance 524 is defined between the first tube structure 520 and the second tube structure 522. In a particular embodiment, fuel can be supplied to combustor interior 615 through clearance 524 as indicated by flow arrows 532.

First tube structure 520 and second tube structure 522 define a coaxial waveguide for delivering electromagnetic radiation to combustor interior 615. Electromagnetic radiation propagates in TEM mode along clearance 524 defined between first tube structure 520 and second tube structure 522. As discussed in detail above, the electromagnetic radiation generates a tangle of plasma streamers that produces free electrons and ultraviolet radiation. This leads to the production of radicals that support the afterburning of unburned CO and UHC in the combustor.

Another implementation of this exemplary embodiment is depicted in FIG. 6. In FIG. 6, a single tube structure 520 located within the fuel nozzle is used as the second waveguide. The single tube structure 520 can include a bell mouth 525 to improve inductive coupling with combustor interior 615. In addition, single tube structure 520 can be configured to supply fuel to combustor interior 615 as indicated by flow arrow 532. Electromagnetic radiation can propagate along tube structure 520 by bouncing off the interior walls of tube structure 520 in either TE mode or TM mode. In this manner, the single tube structure 520 of FIG. 6 can provide electromagnetic radiation to the interior 615 of combustor 610, such as to a low temperature region of combustor interior 615.

Those of ordinary skill in the art should readily understand that variations and modifications can be made to the exemplary embodiments disclosed herein without deviating from the scope of the present disclosure. Features described with one embodiment can be combined with features described with respect to another embodiment to yield yet a different embodiment. For instance, the annular manifold waveguide embodiments disclosed herein can be combined with the fuel nozzle waveguide embodiments disclosed herein to provide electromagnetic radiation to a combustor during a combustion process.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. Apparatus for providing electromagnetic radiation to a combustor during a combustion process, the combustor comprising at least one fuel nozzle for supplying a fuel mixture to the combustor, the apparatus comprising:
an electromagnetic radiation source;
a first waveguide coupled to the electromagnetic radiation source; and
a second waveguide coupled to the first waveguide, the second waveguide comprising an electromagnetic radiation outlet positioned to deliver electromagnetic radiation to a low temperature region of the combustor;
wherein during the combustion process, said low temperature region has an operating temperature that is less than a temperature for sustaining combustion of the fuel mixture without said electromagnetic radiation.

2. The apparatus of claim 1, wherein the fuel mixture is a low BTU fuel mixture.

3. The apparatus of claim 1, wherein the second waveguide comprises:
an annular manifold waveguide; and
a branch waveguide extending from said annular manifold waveguide, said branch waveguide comprising said electromagnetic radiation outlet, said electromagnetic radiation outlet positioned adjacent an opening provided in a wall of the combustor, the opening configured for electromagnetic radiation penetration into the combustor.

4. The apparatus of claim 1, wherein the second waveguide comprises a tube structure mounted within a fuel nozzle for the combustor.

5. Apparatus for providing electromagnetic radiation to a combustor during a combustion process, comprising:
an electromagnetic radiation source;
a first waveguide coupled to said electromagnetic radiation source;
an annular manifold waveguide coupled to said first waveguide; and
a branch waveguide coupled to and extending from said annular manifold waveguide, said branch waveguide comprising an electromagnetic radiation outlet positioned adjacent an opening defined in a wall of the combustor.

6. The apparatus of claim 5, wherein the combustor comprises a central fuel nozzle and a plurality peripheral fuel nozzles disposed in a radial spaced apart relationship with respect to said central fuel nozzle, said opening being positioned proximate one of said plurality of peripheral fuel nozzles.

7. The apparatus of claim 5, wherein said opening comprises a dielectric cap.

8. The apparatus of claim 5, wherein said apparatus comprises a plurality of branch waveguides coupled to said annular manifold waveguide, each said branch waveguide comprising an electromagnetic radiation outlet positioned adjacent an opening defined in a wall of the combustor.

9. The apparatus of claim 5, wherein said electromagnetic radiation source comprises a magnetron.

10. The apparatus of claim 5, wherein said electromagnetic radiation source is operated to provide a pulsed electromagnetic radiation signal to said first waveguide.

11. The apparatus of claim 10, wherein said pulsed electromagnetic radiation signal has a carrier frequency of about 1 GHz to about 30 GHz.

12. The apparatus of claim 10, wherein said pulsed electromagnetic radiation signal has a pulse frequency of about 5 KHz to about 50 KHz.

13. The apparatus of claim 5, wherein said electromagnetic radiation outlet comprises a slot antenna.

14. Apparatus for providing electromagnetic radiation to a combustor during a combustion process, comprising:
an electromagnetic radiation source;
a first waveguide coupled to said electromagnetic radiation source; and
a second waveguide coupled to said first waveguide, said second waveguide comprising a first tube structure mounted within a fuel nozzle of the combustor.

15. The apparatus of claim 14, wherein said first tube structure is configured to supply fuel to the combustor.

16. The apparatus of claim 14, wherein said apparatus further comprises a second tube structure mounted within said first tube structure so as to define a clearance between said second tube structure and said first tube structure, said clearance acting as a coaxial waveguide for delivering electromagnetic radiation to the combustor.

17. The apparatus of claim 16, wherein said clearance is configured to supply fuel to the combustor.

18. The apparatus of claim 14, wherein said first tube structure comprises a bell mouth.

19. The apparatus of claim 14, wherein said electromagnetic radiation source comprises a magnetron.

20. The apparatus of claim 14, wherein said electromagnetic radiation source is operated to provide pulsed electromagnetic radiation signal to said first waveguide.
